(19) United States
(12) Patent Application Publication
(10) Pub. No.: US 2021/0269333 A1
(43) Pub. Date: Sep. 2, 2021

(54) Method For Removing Hydrogen Sulfide From Oily Sour Water

(71) Applicant: Charles Holmstrom, Santa Rosa, CA (US)

(72) Inventor: Charles Holmstrom, Santa Rosa, CA (US)

(21) Appl. No.: 17/187,352

(22) Filed: Feb. 26, 2021

Related U.S. Application Data
(60) Provisional application No. 62/982,312, filed on Feb. 27, 2020.

(51) Int. Cl. C02F 1/58; C02F 1/76; C02F 1/52; C02F 1/66

(52) U.S. Cl. CPC C02F 1/58; C02F 1/76; C02F 2101/101; C02F 1/66; C02F 1/52

(57) ABSTRACT

A method and apparatus for treating wastewater from hydrocarbon production, transport, and refining, comprising treating oily sour water with sodium chlorite to remove hydrogen sulfide and kill sulfate reducing and acid producing bacteria from the fluids harvested from oilfield operations, and facilitate the recovery of oil and water free of hydrogen sulfide and devoid of bacteria. The cationic sodium chlorite facilitates better separation of oil and water by coagulating the solids to create emulsion layers of oil, water, and precipitated sulfur solids. The oil is skimmed or decanted and subsequently refined, while the water is pH corrected and then disposed or recycled substantially free of hydrogen sulfide.

### REFERENCE TO RELATED APPLICATIONS

This is a U.S. utility application claiming priority to co-pending U.S. Provisional Patent Application No. 62/982,312, filed on 27 Feb. 2020, entitled “Method for Removing Hydrogen Sulfide from Sour Water.” The contents of this provisional application are fully incorporated herein by reference.

### FIELD

The present invention relates, generally, to treatment of oily sour water. More specifically, the present invention relates to removing hydrogen sulfide and other contaminants and suspended solids from the fluids from the oilfield operations.

### BACKGROUND

The removal of sulfur-based species from liquid or gaseous hydrocarbon streams is a problem that has long challenged many industries. In the oil and natural gas industries, in particular, hydrogen sulfide (H₂S) presents a significant challenge, particularly in the drilling, production, transportation, storage, and processing of crude oil, as well as waste water associated with crude oil. Due to its presence in geological formations, H₂S is generally produced during all oil & gas operations. Reservoirs with high sulfur content are known as “sour” reservoirs.

Hydrogen sulfide (H₂S) is a pungent gas that is colorless, corrosive, and toxic. It is soluble in water, alcohol, and oil. H₂S usually originates from geological sources or bacterial sources. It is a naturally occurring gas that can be found in gas reservoirs, hydrocarbon streams, water, liquid sulfur, etc. Alternatively, H₂S is produced by microbiological processes, for example, the reduction of sulfates by sulfate reducing bacteria (SRBs).

After drilling and during fracturing and production processes, production fluids that are produced from subterranean formation will often contain H2S. Production fluids that include a high concentration of hydrogen sulfide are also referred to as being “sour.” Because it behaves as a weak acid in water, H2S can cause corrosion of steel equipment and pipelines. Natural gas must ordinarily contain less than 4 parts per million (ppm) of hydrogen sulfide before it can be sold. Accordingly, production fluids may be “sweetened” through a process of removing the hydrogen sulfide. Typical hydrogen sulfide physical removal processes or chemical removal processes use an active treatment compound that reacts with the hydrogen sulfide.

“Sour water” is the wastewater that is produced from industrial operations such as oil and gas drilling, as well as from production wells, transportation and storage (via bacterial metabolism), and refinery operations. In addition to the hydrogen sulfide, other impurities in the sour water must be removed before reuse including suspended solids, ammonia and sulfur reducing bacteria.

A conventional sour water stripping operation starts with de-oiling the water and then heating the water using kettle reboilers, thermosiphon reboilers or live steam injection to remove the contaminants. These complex systems often use sieves, baffles and a variety of column configurations to remove the contaminants. These systems are very expensive to operate, extremely dangerous due to necessity of operating at high temperatures, and do not scale up well for very large operations.

Chemical stripping processes are more desirable, but have traditionally been less effective. Numerous approaches to these problems have been developed. Such developments to control hydrogen sulfide downhole include: (1) solid scavengers (i.e., such as zinc oxide or other metal oxides) for complexing hydrogen sulfide in solid form; (2) liquid scavengers (i.e., such as amines, morpholine, triazine or acrolein) for complexing hydrogen sulfide in liquid form; (3) oxidizing chemicals (i.e., mild oxidizers such as nitrite or long-chain amine oxides and strong oxidizers such as peroxides) that convert hydrogen sulfide to forms of sulfur such as elemental sulfur, sulfate or thiosulfate. Similarly, the products used downhole may also be used above ground during field storage, transportation, oil-water separation, and various refinery operations.

Various chemicals, including ferric chloride and sodium bisulfate, have been used as stripping agents, but these chemicals are not highly effective at removing the hydrogen sulfide. Better results have been obtained with triazine, amines, amine oxides and aldehydes such as glyoxal or acrolein. However all of these chemicals either bind or react with the hydrogen sulfide molecules rather than eliminating them. Hydrogen peroxide and potassium permanganate have also been employed for this purpose, but have the drawback of creating the waste products ammonia gas and manganese dioxide solids.

The present invention resolves these issues by approaching the stripping problem in a different manner. Instead of binding the hydrogen sulfide molecule, it converts the molecule into water and sulfate or elemental sulfur. In addition, the present invention facilitates and enhances the separation of “sweetened” oil from the treated water, kills sulfur reducing bacteria, and is much less expensive than methods described in the prior art. This invention is particularly directed toward large scale oil mining, storage, transportation and refining operations.

Various methods have been developed for reducing sulfide in oilfield waste water by means of an oxidizer. Examples of such methods include U.S. Pat. Nos. 9,670,080, 10,392,271, and U.S. 2015/0013987. However, these methods are limited to use in recovered water streams which have already been fractionally separated from the oil, which can add time and expense. Metal catalysts, filter membranes, and other mechanisms are easily fouled due to suspended solids present in the oily water, which cause emulsion problems and make oil recovery difficult.

A need therefore exists for a treatment system and method which can be applied to sour water which contains both oil and suspended solids, without the need for a pre-treating or separation step, which can permit recovery of both the water and oil fractions. Embodiments of the present invention disclosed herein meet these needs.

### SUMMARY

The present invention provides a method of treating sour fluids which enhance the recovery of oil, water, and gas by injecting sodium chlorite into an oily sour water treatment system. The sodium chlorite, in the correct dilution, is injected into the inlet stream of the oily sour water, or sour water and oil mixture contained in a holding vessel.

The oil separated from the water is removed by suitable means such as skimming or decanting. The water is sampled periodically and tested for its level of hydrogen sulfide. As the sodium chlorite reacts with the hydrogen sulfide, it converts the hydrogen sulfide to water and sulfate or elemental sulfur.

The sour water, after being mixed with the sodium chlorite, is circulated in the vessel to provide better contact with the gases in the head space. Contacting the water containing sodium chlorite with the gases in the fluid system also scavenges the hydrogen sulfide contained in the gases in the head space. When test results indicate hydrogen sulfide levels of 5 parts per million or less, the treated water is pumped from the vessel, and the pumped, treated water is now ready for reuse and can be transferred to suitable holding containers for use in the field or disposed in a suitable manner.

### BRIEF DESCRIPTION OF THE OF THE DRAWINGS

A more complete understanding of the present invention may be derived by referring to the detailed description when considered in connection with the figures, wherein like reference numbers refer to similar items throughout the figures and:

FIG. 1 is a diagram of a sour water treatment system.

FIG. 2. is a flow chart of the process.

FIGS. 3A-3B are diagrams of laminar flow.

FIGS. 4A-4C are possible agitation mechanisms for use with the treatment system.

### DETAILED DESCRIPTION OF THE INVENTION

Before describing selected embodiments of the present disclosure in detail, it is to be understood that the present invention is not limited to the particular embodiments described herein. The disclosure and description herein is illustrative and explanatory of one or more presently preferred embodiments and variations thereof, and it will be appreciated by those skilled in the art that various changes in the design, organization, means of operation, structures and location, methodology, and use of mechanical equivalents may be made without departing from the spirit of the invention.

As well, it should be understood that the drawings are intended to illustrate and plainly disclose presently preferred embodiments to one of skill in the art, but are not intended to be manufacturing level drawings or renditions of final products and may include simplified conceptual views to facilitate understanding or explanation. As well, the relative size and arrangement of the components may differ from that shown and still operate within the spirit of the invention.

Moreover, it will be understood that various directions such as “upper”, “lower”, “bottom”, “top”, “left”, “right”, and so forth are made only with respect to explanation in conjunction with the drawings, and that components may be oriented differently, for instance, during transportation and manufacturing as well as operation. Because many varying and different embodiments may be made within the scope of the concept(s) herein taught, and because many modifications may be made in the embodiments described herein, it is to be understood that the details herein are to be interpreted as illustrative and non-limiting.

It has been discovered that the cationic nature of sodium chlorite particularly facilitates the separation of particulates suspended in the water by neutralizing the negative charge on the particulates of the suspended solids and reducing the zeta potential. Lowered zeta potential results in faster solids separation. In short, sodium chlorite, by reducing or eliminating the negative charge on the solids, also functions as a coagulant. As the solids coalesce out of the solution, this results in faster breaking of the emulsion layer for enhanced oil recovery. This results in oil separating more easily from the water and floating at the top of the tank.

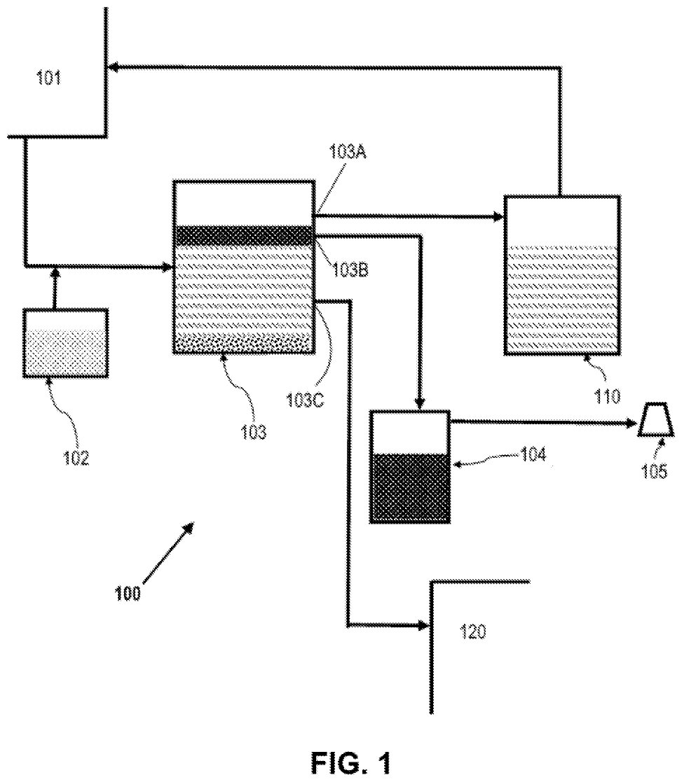

Turning now to FIG. 1, an embodiment of the system 100 for use in a high-flow, oily sour water treatment operation is shown. Usually a field operation or a refinery will collect oily sour water in a source tank 101. The source tank 101 can be anywhere from 500 to 3,000,000 gallons depending on the size of the operation. Source tank 101 serves as the primary point to collect samples for analysis of various chemicals in water including sulfides. It is not usually feasible to treat the oily sour water in the source tank as it may be continuously or discretely receiving additional oily sour water from various streams. Instead, the oily sour water is fed via conduit from the source tank 101 into the treatment tank 103.

An injector tank 102 can comprise a small storage tank for holding and injecting sodium chlorite. In most cases, shipping containers, or intermediate bulk container totes (commonly known as IBCs), can serve as the injector tanks. These containers may be disposable or permanent, and may be of virtually any sizes, as their function is simply to store sodium chlorite for the treatment reaction. It may also be convenient to adjust the concentration of the sodium chlorite solution in the injector tank 102 to add a desired amount at a desired rate.

The resulting mixture of liquid from the source tank 101 and sodium chlorite from the injector tank 102 is conveyed to the treatment tank 103. In an embodiment, the sodium chlorite from the injector tank 102 may be mixed in-line with the oily sour water from the source tank 101. In another embodiment, the sodium chlorite may be received in the treatment tank continuously (i.e., as the tank is being filled), or discretely on an as-needed basis. In yet another embodiment, the treatment tank 103 may comprise a mixer or circulating pump to uniformly contact the sulfides of the oily sour water with the sodium chlorite.

In the course of the treatment and circulation, the suspended solids originally present in the oily water, causing emulsion problems, are separated. Due to the higher specific gravity of the solids, they become suspended in the water phase and settle faster, with the sodium chlorite functioning as a coagulant. Faster separation of solids can translate into faster breaking of the emulsion layer, for cleaner, higher, and faster oil recovery since in the absence of an emulsion layer the oil separates more easily from the water and floats to a layer on top of the treatment tank 103.

In an embodiment, the treatment tank 103 can comprise an overflow outlet 103A, a skim outlet 103B, and a water outlet 103C. The overflow outlet 103A is the topmost of the three outlets, and can be used in the event that an influx of sour water exceeds the capacity of the treatment tank 103. The overflow outlet 103A connects the treatment tank 103 to an overflow tank 110, where the excess oily sour water is in turn pumped back into the source tank 101 for re-treatment. In an embodiment, the treatment tank 103 may comprise a nitrogen line to clear vapors from the head space to through the overflow outlet 103A.

Once the mixture is settled and, if necessary, a sufficient amount of fluid is transferred to the overflow tank 110, the skim outlet can 103B receive fluid from the oil phase level as well as vapors in the head space of the oily sour water. In an embodiment, the skim outlet 103B is controlled by a nozzle or valve. The oil and/or vapors are then transferred to the skim tank 104 (which can include a relief system 105, which may comprise an automatic relief valve, manual valve, or check valve). The vapors can be burnt to dispose of light hydrocarbon gases, and the remaining heavy oil can be further processed in a refinery.

Finally, the water outlet 103C can receive the water phase from the water phase level of the treatment tank 103. Since the liquid are in motion during most of the process, the precipitated sulfur rarely clogs lines, but if desired, a filter may be used to catch coagulated sulfur solids. The water phase with coagulated sulfur can be conveyed from the treatment tank 103 to the treated water conduit 120, which can lead either to disposal or to be returned to the field for re-use.

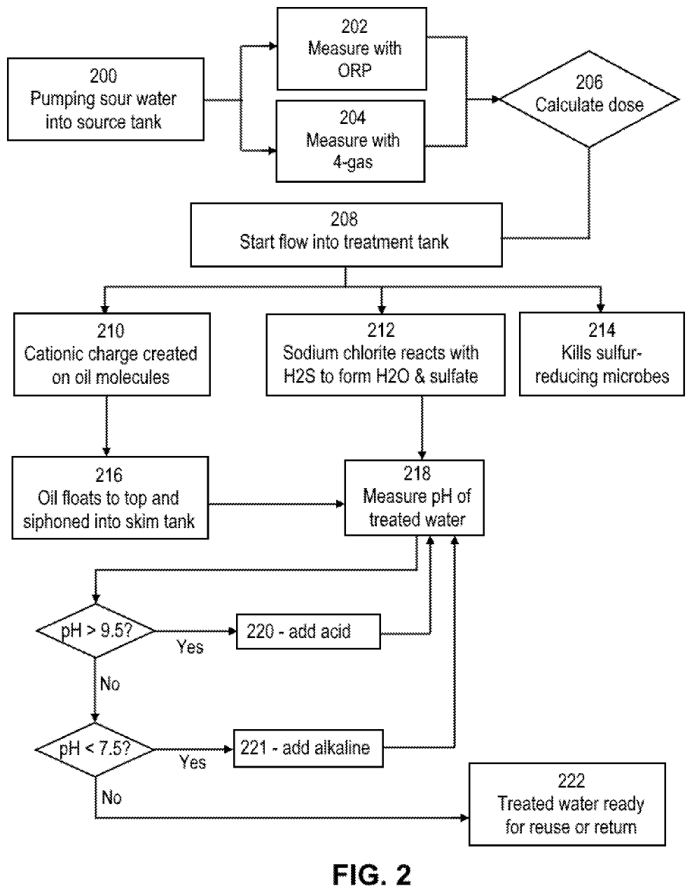

Turning now to FIG. 2, the process is shown as a method step flowchart. In an embodiment, the treatment tank 103 comprises an oxidation-reduction potential (ORP) electrode and a four-gas meter. The principle behind the ORP measurement is the use of an inert metal electrode (platinum, sometimes gold), which, due to its low resistance, will give up electrons to an oxidant or accept electrons from a reductant. The ORP electrode will continue to accept or give up electrons until it develops a potential, due to the build-up charge, which is equal to the ORP of the solution.

ORP is not a good method for measuring concentration due to its logarithmic dependence on concentration and its dependence on multiple solution components. The best use of an ORP measurement is in monitoring and controlling oxidation-reduction reactions. Therefore, it is important to measure the ORP of the solution received from the source tank 101, prior to the opening of the injector tank 102, to establish a starting point before the oxidation of hydrogen sulfide commences. Oily sour waters from different sources with same level of hydrogen sulfide may have different ORP readings.

Therefore, the test water needs to be analyzed in the laboratory to measure the starting concentration of hydrogen sulfide with the corresponding ORP reading, followed by the addition of the oxidant to a desired level of hydrogen sulfide and the measurement of the corresponding ORP readings. These specific ORP readings will be used in the field to monitor the residual level of hydrogen sulfide in the treated water. The ORP is therefore best understood as a proxy for H₂S concentration rather than as a direct measurement, since it can be affected by other chemicals which may be present.

In an embodiment, the first step 200 comprises an initial calibration level of oily sour water being pumped into the treatment tank 103 from the source tank 101. A standard ORP sensor is used 202 to measure the tendency of the oily sour water to consume oxygen. Additionally, a standard four-gas meter 204 is used to measure hydrogen sulfide levels. The concentration and quantity of sodium chlorite to be added is calculated based on the concentration and known chemical reaction rates 206.

In an embodiment of the method, is maximally convenient to add just enough sodium chlorite to convert all sulfides to elemental sulfur. An example of the dimensions (given a cylindrical treatment tank), concentrations, and flow ratios utilized to calculate the hydrogen sulfide reaction are shown below as Tables 1-3. Then, depending on analysis of the oily sour water in the treatment tank 103, additional sodium chlorite solution can be injected as needed.

TABLE 1
Dimensional calculations for Treatment Tank
Treatment Tank Dimensions

| | | |
|---|---|---|
| Diameter | 14 | ft |
| Water Height | 10 | ft |
| Volume | 1,539 | Cu ft |
| | 11,514 | gal |
| | 95,914 | Lbs |
| H₂S in Water | 2.0% | |
| H₂S in Water | 1918.27 | lbs |
| H₂S in Water | 56.4 | mol |

TABLE 2
Conversion calculations for H2S
Conversion of H₂S to S

| | | |
|---|---|---|
| Sodium Chlorite required | 28.2 | moles |
| | 2553 | lbs |
| % Sodium Chlorite used | 15% | |
| Sodium Chlorite required | 17,020 | lbs |
| | 1,818 | gal |

TABLE 3
Calculation of flow ratios
Oily Sour Water to Sodium Chlorite Flow
Ratio

| | | |
|---|---|---|
| Water to Sodium Chlorite | 5.64 | lbs/lb |
| Ratio | 6.33 | gal/gal |

Once the dosage is calculated, the appropriate concentration of sodium chlorite is added to the injection tank and pumped into the treatment tank 208. The chemical comprises 3 moles of chlorite reacting with 3 moles of sulfide to produce a mixture of elemental sulfur and soluble sulfate:

NaClO₂ 2SH— 2H+→2S & NaCl & 2H₂O

2NaClO₂+SH—→SO₄— & 2NaCl & H+

Depending upon the pH, the relative amount of elemental sulfur and sulfate will vary, which will impact the consumption of chlorite. In particular, the particulate takes on a charge 210 separating the particulate from the water, the oil molecules separate and float to the top, the sodium chlorite and hydrogen sulfide combine in a chemical reaction resulting in water and sulfate 212, and the sulfur reducing bacteria is destroyed and/or diminished 214.

In the event the influx of oily sour water exceeds the treatment tank capacity, the overflow of oily sour water is conveyed to the overflow tank 110 as depicted and described in FIG. 1. Once a sufficient quantity of oily sour water is treated to undergo phase separation, the oil can be conveyed to the skim tank 216, again as depicted and described in FIG. 1.

The pH of the effluent water, after it is treated with sodium chlorite, is measured 218. If it is above 9.5, sufficient phosphoric acid is added to reduce the pH 220; if it is below 7.5, sodium hydroxide or soda ash is added to increase the pH 221. After correction of pH, the water is fully treated and is ready for return or reuse 222. (In an embodiment, this pH correction may take place prior to the treatment with sodium chlorite, i.e., with the influent water measured rather than the effluent).

It is not necessarily important to have a specific or a constant pH for the processing of the oily sour water itself. However, the pH of the water product used in oilfield applications is normally desired to be between 7 to 10. Certain additives, such as crosslinkers, do not function well at a pH below 7 and fluids above a pH of 10 can cause metal precipitation problems. Additionally, if the pH of water goes below 6, the sodium chlorite may react with free acid and create chlorine dioxide. Also, given the need for consistent ORP readings, it is better to keep the pH within a narrow operating range of between 7.5 and 9.5.

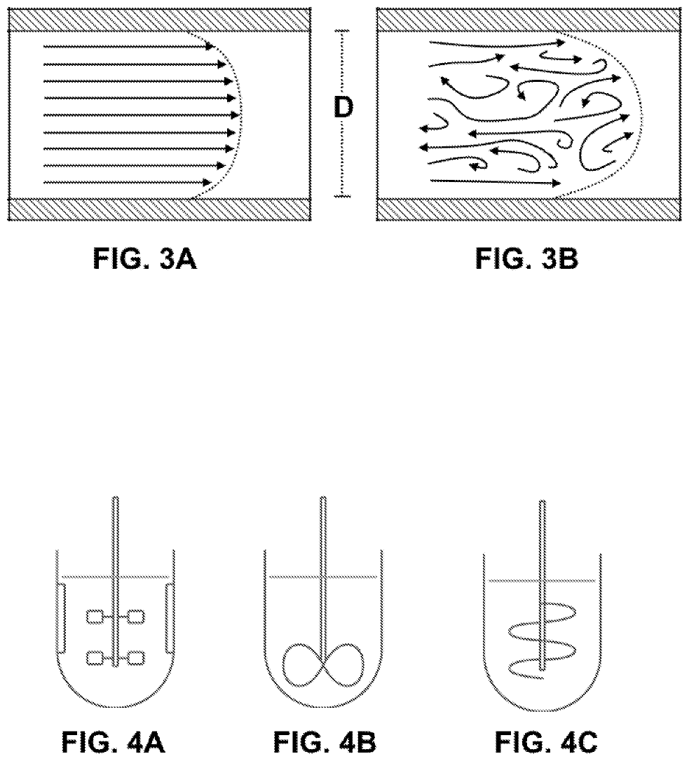

In an embodiment, the oily sour water and sodium chlorite solution may be mixed by transport to the treatment tank. It is well known that a turbulent flow rapidly mixes a scalar, and often turbulence is a welcome ingredient of a process where efficient mixing is required. The onset of turbulence can be predicted by the dimensionless Reynolds number (NRe). As depicted in FIGS. 3A-3B, for flow in a pipe of diameter D, for “fully developed” flow, laminar flow (FIG. 3A) occurs when NRe<2300 and turbulent flow (FIG. 3B) occurs when NRe>2900.

Since, turbulent mixing is achieved at a Reynolds number greater than 2900, it is recommended that for the most rapid mixing, the transfer pump provide a turbulent flow. A linear velocity of about 4 feet per second easily achieves the desired turbulence and the rapid mixing. A pump delivering the desired velocity may be installed to convey the oily sour water (or oily sour water and sodium chlorite, if they are introduced in the same line) to the treatment tank, at a flow rate sufficient to achieve an NRe of 2900 should be installed.

Other modifications such as in-line flow mixers, eductors, packing, may be used to enhance mixing. For instance, the treatment tank 103 may utilize any of the agitators depicted in FIGS. 4A-4C to enhance the reactivity of the sodium chlorite.

Many modifications and variations of this invention may be made without departing from its spirit and scope, as will be appreciated by those skilled in the art. For example, the process could be used on oily sour water in individual tanks, or in tanks not even used in oily sour oil service, and that are not part of a constant flow system with a source tank or overflow tank or skim tank. The embodiments as described herein are chosen and described in order to best explain the principles of the invention and its practiced applications.

### EXAMPLES

For all the below examples, except Example 6, oily water was sourced from a refinery which had less than 5 PPM hydrogen sulfide, and the sulfide level was increased by adding sodium hydrogen sulfide. Example 6 comprised two IBCs of oily sour water obtained for a field trial containing 300-400 PPM of hydrogen sulfide.

Example 1: To 5 gallons of oily sour water was added 9.3 gms of sodium hydrogen sulfide to adjust the equivalent H₂S content to 300 PPM. 31% sodium chlorite was slowly injected. Initial ORP reading was −460 mv. During the addition of sodium chlorite, the ORP reading changed very quickly showing a very fast reaction. Sodium chlorite addition was stopped at −80 mv. Total amount of 31% sodium chlorite consumed was 32.6 gms. The emulsion layer was completely broken and the solids were floating only in the water phase.

Example 2: To 5 gallons of oily sour water with solids was added 9.3 gms of sodium hydrogen sulfide to adjust the equivalent H₂S content to 300 PPM. 130 gms of 30% dimethyllaurylamine oxide (another popular H₂S scavenger) was added to the water. Initial ORP reading was −460 mv. The ORP reading changed very slowly showing a very slow reaction. After 48 hours, the ORP reading was −110 mv. The oily layer floated to the top with a small emulsion layer. The water remained turbid and slowly cleared after 12 hours of settling implying that dimethyllaurylamine fails to act as a coagulant. A very fine layer of yellowish solids could be seen at the bottom.

Example 3: To 5 gallons of oily sour water with solids was added 9.3 gms of sodium hydrogen sulfide to adjust the equivalent H₂S content to 300 PPM. 31% sodium chlorite was slowly injected. Initial ORP reading was −460 mv. During the addition of sodium chlorite, the ORP reading changed very quickly showing a very fast reaction. Sodium chlorite addition was stopped at to −80 mv. Total amount of 31% sodium chlorite consumed was 31.7 gms. The emulsion layer was completely broken and the solids were floating only in the water phase. The oily layer floated to the top. A very fine layer of yellowish solids could be seen at the bottom within 1 hour indicating rapid settling of coagulated solids.

Example 4: To 5 gallons of oily sour water with solids was added 9.3 gms of sodium hydrogen sulfide to adjust the equivalent H₂S content to 300 PPM. 12 gms of 50% hydrogen peroxide was added to the water. Initial ORP reading was −460 mv. The ORP reading changed rapidly showing a fast reaction. After 2 hours, the ORP reading was −120 mv. The oily layer floated to the top with a larger emulsion layer than Example 2. The water remained turbid and slowly cleared after 12 hours of settling implying that hydrogen peroxide fails to act as a coagulant. A very fine layer of yellowish solids could be seen at the bottom. The emulsion layer did not disappear even after 12 hours.

Example 5: To 5 gallons of oily sour water was added 9.3 gms of sodium hydrogen sulfide to adjust the equivalent H₂S content to 300 PPM. 31% sodium chlorite was slowly injected. Initial ORP reading was −460 mv. During the addition of 25 gms sodium chlorite, the ORP reading changed very quickly showing a very fast reaction. Sodium chlorite addition was stopped at to −100 mv. Additionally, 6.8 gms of 31% sodium chlorite was slowly added until the ORP reading was −85 mv. The emulsion layer was completely broken and the solids were floating only in the water phase. Turbidity of the water cleared withing an hour confirming that sodium chlorite functions as a coagulant.

Example 6: To 500 gallons of oil sour water was added 50% caustic to adjust the pH of the water to 8.1. 31% sodium chlorite was slowly injected. Initial ORP reading was −450 mv. During the addition of sodium chlorite, the ORP reading changed very quickly showing a very fast reaction. Sodium chlorite addition was stopped at to −100 mv. The emulsion layer was completely broken and the solids were floating only in the water phase. Turbidity of the water cleared withing two hours showing that sodium chlorite also functions as a coagulant.

1. A method for removing hydrogen sulfide from oily sour water comprising:
conveying a quantity of oily sour water from a source tank to a reaction tank;
conveying a quantity of sodium chlorite from an injection tank to the reaction tank;
agitating the combination of oily sour water and sodium chlorite within the reaction tank to form an oil phase, an aqueous phase, and a sulfur precipitate;
skimming or decanting the oil phase to a skim tank; and
conveying the aqueous phase to a disposal tank or recycling conduit.

2. The method of claim 1, wherein the step of conveying a quantity of oily sour water from a source tank to a reaction tank further comprises measuring the oxidation-reduction potential and hydrogen sulfide concentration of the quantity of oily sour water conveyed.

3. The method of claim 2, wherein the step of conveying a quantity of sodium chlorite from an injection tank to the reaction tank further comprises adjusting the concentration and/or quantity of sodium chlorite based on the measurements of oxidation-reduction potential and hydrogen sulfide concentration.

4. The method of claim 1, further comprising the step of measuring the pH of the aqueous phase.

5. The method of claim 4, further comprising the step of adding phosphoric acid to the aqueous phase if the pH is above 9.5, or adding sodium hydroxide if the pH is below 7.5, until the pH is between 7.5 and 9.5.

6. A system for removing hydrogen sulfide from oily sour water, the system comprising:
a source tank containing oily sour water;
an injection tank containing a solution of sodium chlorite; and
a reaction tank in fluid communication with the source tank and the injection tank, wherein the reaction tank receives oily sour water from the source tank and a solution of sodium chlorite from the injection tank, and wherein the reaction tank comprises an overflow outlet, a skim outlet below the overflow outlet, a water outlet below the skim outlet, and a mixer or pump agitating the mixture of oily sour water and sodium chlorite solution;
an overflow tank receiving vapor and excess oily sour water through the overflow outlet;
a skim tank receiving oil from the skim outlet; and
a treated water conduit receiving water and elemental sulfur from the water outlet.
